(19) United States
(12) Patent Application Publication
(10) Pub. No.: US 2017/0212930 A1
(43) Pub. Date: Jul. 27, 2017

(54) HYBRID ARCHITECTURE FOR PROCESSING GRAPH-BASED QUERIES

(71) Applicant: LINKEDIN CORPORATION, Mountain View, CA (US)

(72) Inventors: Andrew J. Carter, Mountain View, CA (US); Yongling Song, Dublin, CA (US); Joshua D. Ehrlich, Mountain View, CA (US); Roman A. Averbukh, Sunnyvale, CA (US); Scott M. Meyer, Berkeley, CA (US); Jiahong Zhu, San Jose, CA (US)

(73) Assignee: LINKEDIN CORPORATION, Mountain View, CA (US)

(21) Appl. No.: 15/003,520

(22) Filed: Jan. 21, 2016

(51) Int. Cl. G06F 17/30

(52) U.S. Cl. CPC G06F 17/30451; G06F 17/30958; G06F 17/30867

(57) ABSTRACT

The disclosed embodiments provide a system for processing data. During operation, the system launches a set of child processes for processing queries of a graph database storing a graph, wherein the graph comprises a set of nodes, a set of edges between pairs of nodes in the set of nodes, and a set of predicates. When a query of the graph database is received, the system transmits the query to one or more of the child processes. Next, the system receives a result of the query from the one or more child processes. The system then provides the result in a response to the query.

### RELATED APPLICATION

The subject matter of this application is related to the subject matter in a co-pending non-provisional application by inventors Srinath Shankar, Rob Stephenson, Andrew Carter, Maverick Lee and Scott Meyer, entitled “Graph-Based Queries,” having Ser. No. 14/858,178, and filing date Sep. 18, 2015 (Attorney Docket No. LI-P1664.LNK.US).

### BACKGROUND

Field

The disclosed embodiments relate to graph databases. More specifically, the disclosed embodiments relate to hybrid architectures for processing graph-based queries.

Related Art

Data associated with applications is often organized and stored in databases. For example, in a relational database data is organized based on a relational model into one or more tables of rows and columns, in which the rows represent instances of types of data entities and the columns represent associated values. Information can be extracted from a relational database using queries expressed in a Structured Query Language (SQL).

In principle, by linking or associating the rows in different tables, complicated relationships can be represented in a relational database. In practice, extracting such complicated relationships usually entails performing a set of queries and then determining the intersection of or joining the results. In general, by leveraging knowledge of the underlying relational model, the set of queries can be identified and then performed in an optimal manner.

However, applications often do not know the relational model in a relational database. Instead, from an application perspective, data is usually viewed as a hierarchy of objects in memory with associated pointers. Consequently, many applications generate queries in a piecemeal manner, which can make it difficult to identify or perform a set of queries on a relational database in an optimal manner. This can degrade performance and the user experience when using applications.

A variety of approaches have been used in an attempt to address this problem, including using an object-relational mapper, so that an application effectively has an understanding or knowledge about the relational model in a relational database. However, it is often difficult to generate and to maintain the object-relational mapper, especially for large, real-time applications.

Alternatively, a key-value store (such as a NoSQL database) may be used instead of a relational database. A key-value store may include a collection of objects or records and associated fields with values of the records. Data in a key-value store may be stored or retrieved using a key that uniquely identifies a record. By avoiding the use of a predefined relational model, a key-value store may allow applications to access data as objects in memory with associated pointers, i.e., in a manner consistent with the application's perspective. However, the absence of a relational model means that it can be difficult to optimize a key-value store. Consequently, it can also be difficult to extract complicated relationships from a key-value store (e.g., it may require multiple queries), which can also degrade performance and the user experience when using applications.

### BRIEF DESCRIPTION OF THE FIGURES

FIG. 1 shows a schematic of a system in accordance with the disclosed embodiments.

FIG. 2 shows a graph in a graph database in accordance with the disclosed embodiments.

FIG. 3 shows a system for processing queries of a graph database in accordance with the disclosed embodiments.

FIG. 4 shows an exemplary sequence of operations involved in processing a query of a graph database in accordance with the disclosed embodiments.

FIG. 5 shows a flowchart illustrating the processing of queries of a graph database in accordance with the disclosed embodiments.

FIG. 6 shows a flowchart illustrating the process of managing execution of a child process associated with processing queries of a graph database in accordance with the disclosed embodiments.

FIG. 7 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

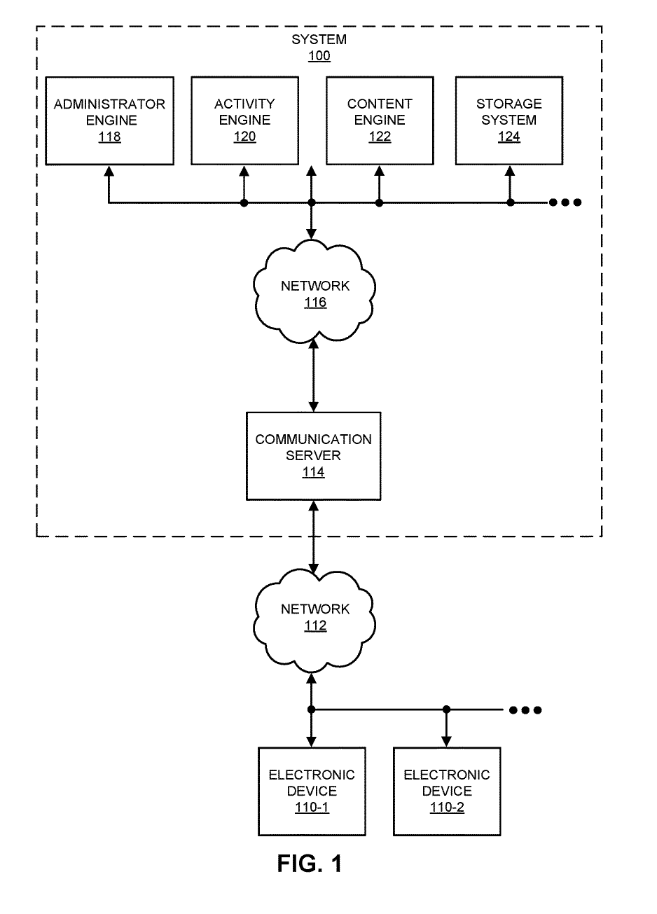

The disclosed embodiments provide a method, apparatus and system for processing queries of a graph database. A system 100 for performing a graph-storage technique is shown in FIG. 1. In this system, users of electronic devices 110 may use a service that is, at least in part, provided using one or more software products or applications executing in system 100. As described further below, the applications may be executed by engines in system 100.

Moreover, the service may, at least in part, be provided using instances of a software application that is resident on and that executes on electronic devices 110. In some implementations, the users may interact with a web page that is provided by communication server 114 via network 112, and which is rendered by web browsers on electronic devices 110. For example, at least a portion of the software application executing on electronic devices 110 may be an application tool that is embedded in the web page, and that executes in a virtual environment of the web browsers. Thus, the application tool may be provided to the users via a client-server architecture.

The software application operated by the users may be a standalone application or a portion of another application that is resident on and that executes on electronic devices 110 (such as a software application that is provided by communication server 114 or that is installed on and that executes on electronic devices 110).

A wide variety of services may be provided using system 100. In the discussion that follows, a social network (and, more generally, a network of users), such as an online professional network, which facilitates interactions among the users, is used as an illustrative example. Moreover, using one of electronic devices 110 (such as electronic device 110-1) as an illustrative example, a user of an electronic device may use the software application and one or more of the applications executed by engines in system 100 to interact with other users in the social network. For example, administrator engine 118 may handle user accounts and user profiles, activity engine 120 may track and aggregate user behaviors over time in the social network, content engine 122 may receive user-provided content (audio, video, text, graphics, multimedia content, verbal, written, and/or recorded information) and may provide documents (such as presentations, spreadsheets, word-processing documents, web pages, etc.) to users, and storage system 124 may maintain data structures in a computer-readable memory that may encompass multiple devices, i.e., a large-scale storage system.

Note that each of the users of the social network may have an associated user profile that includes personal and professional characteristics and experiences, which are sometimes collectively referred to as ‘attributes’ or ‘characteristics.’ For example, a user profile may include: demographic information (such as age and gender), geographic location, work industry for a current employer, an employment start date, an optional employment end date, a functional area (e.g., engineering, sales, consulting), seniority in an organization, employer size, education (such as schools attended and degrees earned), employment history (such as previous employers and the current employer), professional development, interest segments, groups that the user is affiliated with or that the user tracks or follows, a job title, additional professional attributes (such as skills), and/or inferred attributes (which may include or be based on user behaviors). Moreover, user behaviors may include: log-in frequencies, search frequencies, search topics, browsing certain web pages, locations (such as IP addresses) associated with the users, advertising or recommendations presented to the users, user responses to the advertising or recommendations, likes or shares exchanged by the users, interest segments for the likes or shares, and/or a history of user activities when using the social network. Furthermore, the interactions among the users may help define a social graph in which nodes correspond to the users and edges between the nodes correspond to the users' interactions, interrelationships, and/or connections. However, as described further below, the nodes in the graph stored in the graph database may correspond to additional or different information than the members of the social network (such as users, companies, etc.). For example, the nodes may correspond to attributes, properties or characteristics of the users.

As noted previously, it may be difficult for the applications to store and retrieve data in existing databases in storage system 124 because the applications may not have access to the relational model associated with a particular relational database (which is sometimes referred to as an ‘object-relational impedance mismatch’). Moreover, if the applications treat a relational database or key-value store as a hierarchy of objects in memory with associated pointers, queries executed against the existing databases may not be performed in an optimal manner. For example, when an application requests data associated with a complicated relationship (which may involve two or more edges, and which is sometimes referred to as a ‘compound relationship’), a set of queries may be performed and then the results may be linked or joined. To illustrate this problem, rendering a web page for a blog may involve a first query for the three-most-recent blog posts, a second query for any associated comments, and a third query for information regarding the authors of the comments. Because the set of queries may be suboptimal, obtaining the results may, therefore, be time-consuming. This degraded performance may, in turn, degrade the user experience when using the applications and/or the social network.

In order to address these problems, storage system 124 may include a graph database that stores a graph (e.g., as part of an information-storage-and-retrieval system or engine). Note that the graph may allow an arbitrarily accurate data model to be obtained for data that involves fast joining (such as for a complicated relationship with skew or large ‘fan-out’ in storage system 124), which approximates the speed of a pointer to a memory location (and thus may be well suited to the approach used by applications).

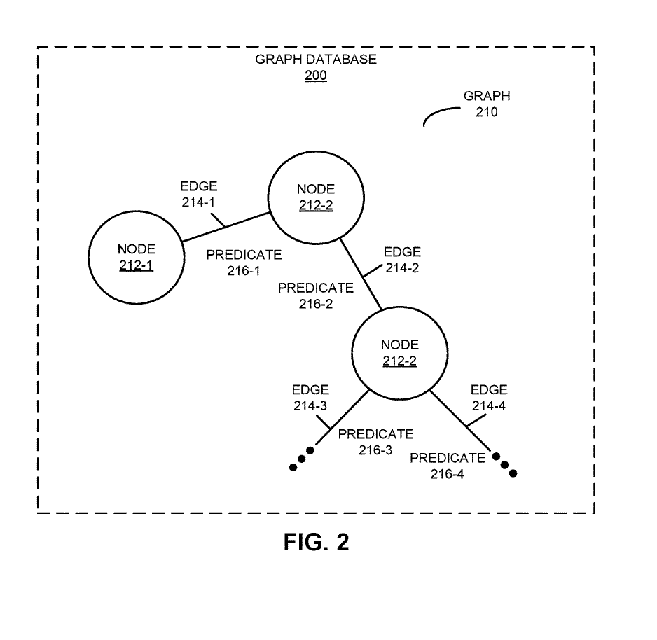

FIG. 2 presents a block diagram illustrating a graph 210 stored in a graph database 200 in system 100 (FIG. 1). Graph 210 may include nodes 212, edges 214 between nodes 212, and predicates 216 (which are primary keys that specify or label edges 214) to represent and store the data with index-free adjacency, i.e., so that each node 212 in graph 210 includes a direct edge to its adjacent nodes without using an index lookup.

Note that graph database 200 may be an implementation of a relational model with constant-time navigation, i.e., independent of the size N, as opposed to varying as log(N). Moreover, all the relationships in graph database 200 may be first class (i.e., equal). In contrast, in a relational database, rows in a table may be first class, but a relationship that involves joining tables may be second class. Furthermore, a schema change in graph database 200 (such as the equivalent to adding or deleting a column in a relational database) may be performed with constant time (in a relational database, changing the schema can be problematic because it is often embedded in associated applications). Additionally, for graph database 200, the result of a query may be a subset of graph 210 that preserves intact the structure (i.e., nodes, edges) of the subset of graph 210.

The graph-storage technique may include embodiments of methods that allow the data associated with the applications and/or the social network to be efficiently stored and retrieved from graph database 200. Such methods are described in a co-pending non-provisional application by inventors Srinath Shankar, Rob Stephenson, Andrew Carter, Maverick Lee and Scott Meyer, entitled “Graph-Based Queries,” having Ser. No. 14/858,178, and filing date Sep. 18, 2015 (Attorney Docket No. LI-P1664.LNK.US), which is incorporated herein by reference.

Referring back to FIG. 1, the graph-storage techniques described herein may allow system 100 to efficiently and quickly (e.g., optimally) store and retrieve data associated with the applications and the social network without requiring the applications to have knowledge of a relational model implemented in graph database 200. Consequently, the graph-storage techniques may improve the availability and the performance or functioning of the applications, the social network and system 100, which may reduce user frustration and which may improve the user experience. Therefore, the graph-storage techniques may increase engagement with or use of the social network, and thus may increase the revenue of a provider of the social network.

Note that information in system 100 may be stored at one or more locations (i.e., locally and/or remotely). Moreover, because this data may be sensitive in nature, it may be encrypted. For example, stored data and/or data communicated via networks 112 and/or 116 may be encrypted.

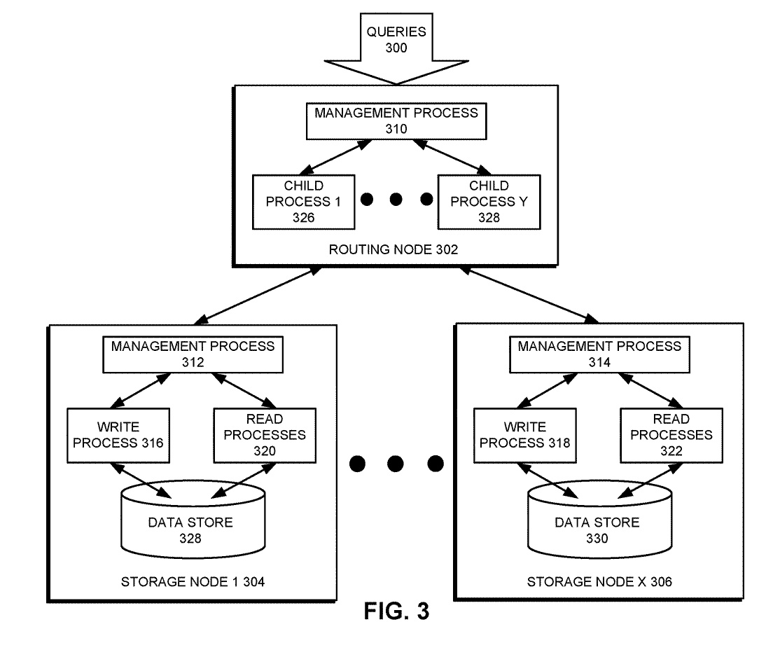

In one or more embodiments, effective querying of graph database 200 is further enabled by a hybrid architecture containing a number of processes executing in multiple runtime environments. As shown in FIG. 3, the hybrid architecture includes a routing node 302 and a number of storage nodes (e.g., storage node 1 304, storage node x 306). Each of the routing and storage nodes further includes a management process (e.g., management processes 310-314) and a number of child processes managed by the management process. More specifically, routing node 320 includes a set of child processes (e.g., child process 1 326, child process y 328) that is managed by management process 310, and the storage nodes each include a single write process (e.g., write processes 316, 318) and one or more read processes (e.g., read processes 320, 322) as child processes that are managed by the corresponding management process (e.g., management processes 312, 314). Each of these components is described in further detail below.

Routing node 302 may receive queries 300 to the graph database and route each query to one or more storage nodes. For example, routing node 302 may obtain a query from a representational state transfer (REST) request and direct the query to some or all of the storage nodes based on a load-balancing and/or sharding technique. In turn, the storage nodes may execute the query against a corresponding data store (e.g., data stores 328-300) and/or index structure containing some or all of the graph database and return one or more subsets of results of the executed query to routing node 302. Routing node 302 may then aggregate the subsets into a single result and return the result in a response to the query, such as a REST response.

Within each node, the management process may launch the corresponding child processes and manage the lifecycles of the child processes. The child processes may receive queries of the graph database from the management process, search the data stores and/or index structures in the node for records matching the queries, and return results of the queries that contain the records to the management process.

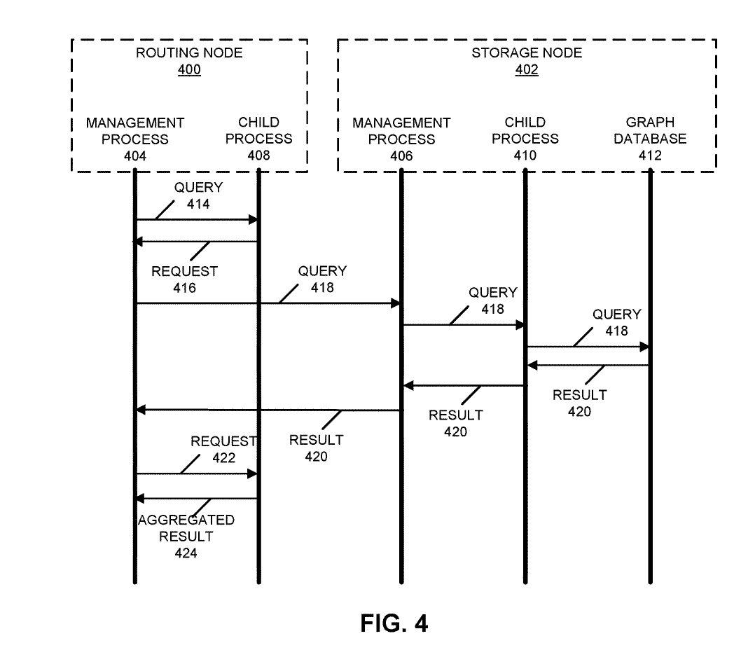

Each management process may also communicate with the child processes in the same node and/or management processes in other nodes to process queries 300. For example, management process 310 may receive a query and use inter-process communication (IPC) and one or more input buffers in shared memory in routing node 302 to communicate one or more portions of the query to the corresponding child processes. The child processes in routing node 302 may process the portions of the query received from management process 310 and request additional information or data to complete the query. In response to the requested information, management process 310 may transmit one or more portions of the query to management processes (e.g., management processes 312-314) in one or more storage nodes, and the management process in each storage node may use IPC and one or more input buffers in the storage node to communicate the received portions to one or more child processes in the storage node. The child processes in the storage node may execute the corresponding portions of the query against the data store and/or index structure in the storage node and write the results of the query to one or more output buffers in shared memory, and the management process in the storage node may read the results from the output buffer(s) and transmit the results to management process 310. Finally, management process 310 may use one or more child processes in routing node 302 to aggregate multiple subsets of results from multiple storage nodes (if results of the query are returned separately from multiple storage nodes) and provide the aggregated results in a response to the query. Processing of graph database queries by multiple nodes is described in further detail below with respect to FIG. 4.

As mentioned above, each storage node may include multiple read processes for reading from a data store containing some or all of the graph database. To improve querying of the graph database, the management process in the storage node may identify a size of each read query and transmit the query to a read process with a resource usage limit that accommodates the size. For example, the management process may associate each query with a “cost” metric such as processor usage, memory usage, disk input/output (I/O), and/or a processing time (e.g., number of milliseconds). The cost metric may be determined based on the complexity of the query and/or estimated by an end user or service from which the query was received. The management process may then assign the query and other queries with similar cost metrics to a read process with a resource allocation that is capable of handling the cost metrics so that queries with longer processing times or higher costs execute on one process and do not interfere with queries with shorter processing times or lower costs that execute on another process. If a given query exceeds the estimated cost metric and/or the resource usage limit of the read process, the query and/or read process may be terminated to prevent the query from consuming excessive resources and/or slowing the processing of other queries on the node.

Alternatively, the management process may assign queries to read processes in a way that balances workload among the read processes. For example, the management process may write queries or portions of queries to input buffers shared with the read processes so that all of the read processes have roughly the same query-processing workload and/or average query-processing time.

The management process may further prioritize the processing of some queries over others, in lieu of or in addition to managing the resource- or workload-based processing of queries by the child processes. For example, queries received by the management process may be associated with different priorities. The management process may assign queries with higher priorities to child processes with higher resource usage limits or fewer pending queries and queries with lower priorities to child processes with lower resource usage limits or more pending queries. The management process and/or child processes may also order the queries in each input buffer in a way that reflects the respective priorities of the queries.

In one or more embodiments, the management process in each node executes in a separate runtime environment from that of the child processes. In addition, the runtime environment of the management process may be selected for stability, while the runtime environment of the child processes may be selected for performance. For example, the management process may be implemented as a general-purpose Java (Java™ is a registered trademark of Oracle America, Inc.) process, while the corresponding child processes may be implemented as C++ processes that are configured to evaluate queries of the graph database. The Java process may include mechanisms for handling errors and process termination, while the C++ processes may be optimized for executing low-level vector or set operations related to querying of the graph database.

By executing in a runtime environment that supports error handling and process termination, each management process may include functionality to monitor execution conditions associated with child processes in the same node and manage execution of the child processes based on the execution conditions. As described above, each child process may be associated with a resource usage limit such as a processor usage, memory usage, processing time, and/or disk I/O usage. The child process may report its resource usage by writing a set of metrics to a shared buffer with the management process. If the resource usage of the child process exceeds the corresponding resource usage limit, the management process may terminate the child process to prevent the child process from consuming resources allocated to other child processes in the node.

The management process may also manage execution errors in the child processes. Each execution error may be identified as a system call failure that is classified as recoverable or unrecoverable. A recoverable execution error may represent an execution condition, such as workload-related stress, in which a request that cannot be currently completed by a given process may be completed by another process in the future. An unrecoverable execution error may represent an execution condition, such as corrupted index structures or a mis-configured graph database, in which the request cannot be completed by any process.

Each child process may terminate with an exit value representing the execution error that triggered the termination. The management process may match the exit value to a recoverable or unrecoverable error; if the child process does not provide an exit value, the management process may use a default exit value that can be set to recoverable or unrecoverable. If the child process terminates with a recoverable error, the management process may restart the child process. If the child process terminates with an unrecoverable error, the management process may terminate all processes in the node so that the error can be managed externally.

By processing queries of a graph database using a hybrid architecture with multiple processes, the system of FIG. 2 may improve monitoring and isolation of resources and failures over systems that utilize multiple threads instead of multiple processes. Moreover, use of separate runtime environments to execute management processes and child processes managed by the management processes may allow the runtime environments to be selected for attributes that are conducive to the functionality of each type of process, such as stability, performance, or integration and communication with other services.

Those skilled in the art will appreciate that the system of FIG. 3 may be implemented in a variety of ways. More specifically, routing node 302 and the storage nodes may be provided by a single physical machine, multiple computer systems, one or more virtual machines, a grid, a cluster, one or more databases, one or more filesystems, and/or a cloud computing system. Processes and/or other components of each node may additionally be implemented together and/or separately by one or more software components and/or layers.

For example, each node may represent a separate physical machine in a cluster, and the graph database may be a resource that is partitioned, replicated, and/or distributed among the nodes. A cluster-management framework (not shown) may be used to dynamically add and remove nodes from the cluster, and routing node 302 may use the cluster-management framework to identify storage nodes that are online and available for processing queries.

Alternatively, the graph database may be provided by a single physical machine that contains the entire graph database and processes all queries of the graph database. A management process in the machine may use one or more input buffers in shared memory to assign and/or distribute the queries among a set of child processes, which include a single write process and one or more read processes. The child processes may process the queries and return the results of the queries to the management process in one or more output buffers in shared memory. The management process may then return the results in responses to the queries, such as REST responses.

Those skilled in the art will also appreciate that the system of FIG. 3 may be adapted to other types of functionality. For example, the above-described operation of a management process and multiple child processes in each node of the system may be used to perform other types of distributed tasks that benefit from the separation and limitation of resources and failures in the system.

FIG. 4 shows an exemplary sequence of operations involved in processing a query 414 of a graph database in accordance with the disclosed embodiments. Initially, query 414 is received by a management process 404 in a routing node 400. For example, query 414 may be included in a REST request that is transmitted over a network to routing node 400. Management process 404 may communicate query 414 to a child process 408 in routing node 400, and child process 408 may respond to query 414 with a request 416 for more information. For example, management process 404 may write query 414 to an input buffer that is shared with child process 408, and child process 408 may read query 414 from the input buffer and attempt to retrieve results of query 414 from a local data store or index structure on routing node 400. When child process 408 is unable to retrieve the results (because routing node 400 does not contain the graph database), child process 408 may write request 416 to an output buffer that is shared with management process 404.

After request 416 is received from child process 408, management process 404 may transmit a query 418 for information associated with request 416 to another management process 406 in a storage node 402. For example, management process 404 may transmit a REST request containing query 418 over a network to storage node 402.

Query 418 may match query 414, or query 418 may include a subset of query 414. For example, management process 404 may transmit the entirety of query 414 as query 418 to management process 406 if storage node 402 is selected to process all of query 414, or management process 406 may transmit a portion of query 414 as query 418 to management process 406 and other portions of query 414 to other management processes in other storage nodes if the graph database is sharded across the storage nodes and/or multiple storage nodes are to be used to process query 414.

After query 418 is received from routing node 400, management process 406 may communicate query 418 to a child process 410 in storage node 402, and child process 410 may execute query 418 against a graph database 412 in storage node 402. For example, management process 404 may write query 418 to an input buffer shared with child process 410, and child process 410 may read query 418 from the input buffer and match query 418 to one or more records in graph database 412 that represent a result 420 of query 418.

Child process 410 may then provide result 420 to management process 406, and management process 406 may transmit result 420 to management process 404. For example, child process 410 may write result 420 to an output buffer shared with management process 406, and management process 406 may read result 420 from the output buffer and transmit result 420 over a network to management process 404.

Management process 404 may receive result 420 from management process 406 and/or other results of query 414 from management processes in other storage nodes to which portions of query 414 were transmitted. After all portions of the result associated with query 414 have been received, management process 404 may communicate a request 422 to child process 408 to aggregate the portions of the result, and child process 408 may provide an aggregated result 424 in response to request 422. For example, management process 404 may write result 420, other portions of the result, and request 422 to an input buffer shared with child process 408, and child process 408 may aggregate the portions into aggregated result 424 and write aggregated result 424 to an output buffer shared with management process 404.

Finally, management process 404 may provide aggregated result 424 in a response to query 414. For example, management process 404 may transmit aggregated result 424 in a REST response to a user or service from which a REST request containing query 414 was received.

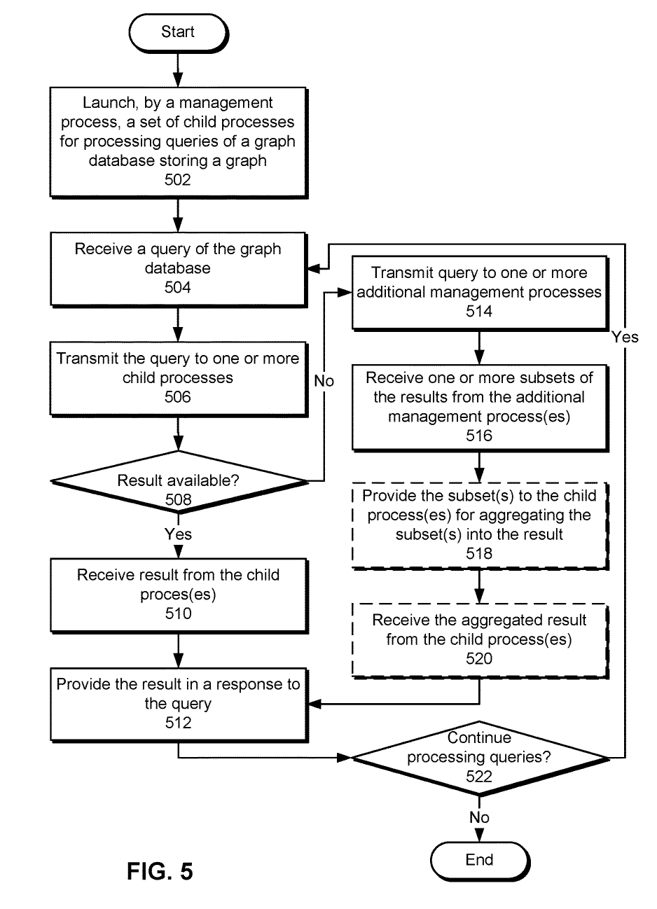

FIG. 5 shows a flowchart illustrating the processing of queries of a graph database in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the technique.

Initially, a set of child processes for processing queries of a graph database storing a graph is launched by a management process (operation 502). The management process may execute in a different runtime environment from that of the child processes. For example, the management process may be a Java process, while the child processes may be C++ processes. As a result, the management process may be more stable than the child processes, while the child processes may have higher performance than the management process.

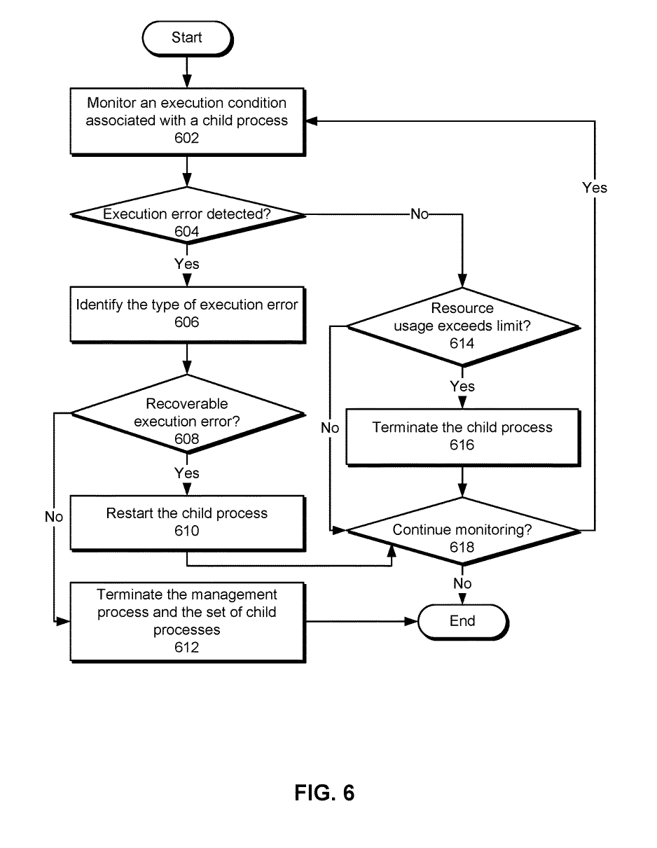

The child processes may include a write process that executes write requests to the graph database and one or more read processes that execute read requests to the graph database. After each child process is launched, the management process may monitor an execution condition associated with the child process and manage execution of the child process based on the monitored execution condition, as described in further detail below with respect to FIG. 6.

Next, a query of the graph database is received (operation 504) by the management process. For example, the management process may receive a query that reads from or writes to the graph database. To process the query, the management process transmits the query to one or more child processes (operation 506) in an attempt to obtain a result (operation 508) of the query from the child processes. For example, the management process may select a child process for processing the query by identifying a size of the query and transmitting the query to the child process with a resource usage limit that matches the size.

If the result is available, the management process receives the result from the child process(es) (operation 510) and provides the result in a response to the query (operation 512). For example, the management process may write the query to one or more input buffers shared with the child process(es), and the child process(es) may process the query by retrieving one or more records matching the query from the graph database. The child process(es) may then write the records to one or more output buffers shared with the management process, and the management process may return the records in the response.

If the result cannot be obtained from the child process(es), the management process transmits the query to one or more additional management processes (operation 514) executing on one or more additional computer systems or nodes. For example, the management process may execute on a routing node that does not contain the graph database. As a result, the management process may transmit one or more portions of the query to other management processes executing on storage nodes that contain the graph database. The management process then receives one or more subsets of the results from the additional management process(es) (operation 516), after the additional management process(es) have used child processes executing on the same nodes to retrieve the subsets of results from the graph database.

The management process optionally provides the subset(s) to the child process(es) on the same computer system for aggregating the subset(s) into the result (operation 518) and receives the aggregated results from the child process(es) (operation 520), if multiple subsets of results are received from the additional management process(es). For example, the management process may write multiple subsets of results to one or more input buffers shared with the child process(es) and receive the aggregated result in an output buffer shared with the child process(es). The management then provides the aggregated result in a response to the query (operation 512).

Process of queries may thus continue (operation 522) during execution of the management process and/or child processes. During processing of the queries, the management process transmits each query to one or more child processes (operations 504-506) and returns a result of the query received from the child process(es) (operations 508-512). If the result is not available locally, the management process transmits the query to other management processes (operation 514), receives one or more subsets of the result from the other management processes (operation 516), and optionally uses the child process(es) to aggregate the subsets into the result (operations 518-520) before returning the result in the response (operation 512). Such processing of queries may continue until the management process is terminated and/or is no longer used to perform querying of the graph database.

FIG. 6 shows a flowchart illustrating the process of managing execution of a child process associated with processing queries of a graph database in accordance with the disclosed embodiments. In one or more embodiments, one or more of the steps may be omitted, repeated, and/or performed in a different order. Accordingly, the specific arrangement of steps shown in FIG. 6 should not be construed as limiting the scope of the technique.

First, an execution condition associated with a child process is monitored (operation 602) by a management process. The execution condition may include an execution error (operation 604) in the child process. For example, the execution error may be detected when the child process terminates unexpectedly.

If an execution error is detected, the type of the execution error is identified (operation 606) to be recoverable or unrecoverable (operation 608). For example, the type of the execution error may be determined from an exit value with which the child process terminates. If the execution error is recoverable, the child process is restarted (operation 610), and monitoring of the child process may be continued (operation 618). If the execution error is unrecoverable, the management process and all child processes managed by the management process are terminated (operation 612) to await an external remedy of the execution error.

The execution condition may also include a resource usage of the child process that is compared to a resource usage limit (operation 614), independently of the detection and management of execution errors in the child process. The resource usage may include a processor usage, memory usage, disk I/O usage, processing time, and/or other metric associated with the resource consumption of the child process. The resource usage limit may represent an allocation of resources to the child process. If the resource usage exceeds the resource usage limit, the child process is terminated (operation 616) to prevent the child process from consuming resources allocated to other child processes. The child process may also optionally be restarted to enable subsequent processing of queries by the child process.

Monitoring of the child process may continue (operation 618) during execution of the child process and/or management process. If monitoring of the child process is to continue, the execution condition of the child process is obtained (operation 602), and any execution errors in the execution condition are managed based on the type of execution error found (operations 604-610). A resource usage of the child process is also obtained from the execution condition, and the child process is terminated and optionally restarted if the resource usage exceeds the resource usage limit for the child process (operations 614-616). Monitoring of the child process may thus continue until the child process and/or management process are no longer used to process queries of the graph database.

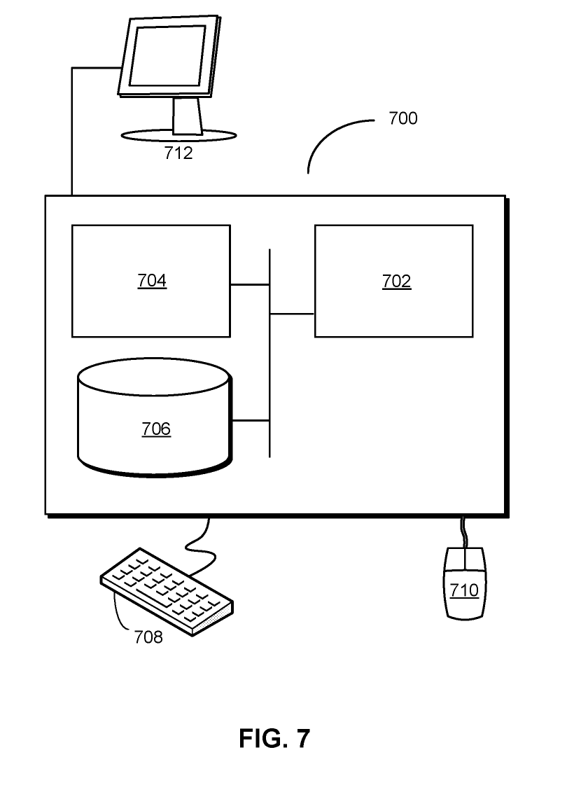

FIG. 7 shows a computer system 700. Computer system 700 includes a processor 702, memory 704, storage 706, and/or other components found in electronic computing devices. Processor 702 may support parallel processing and/or multi-threaded operation with other processors in computer system 700. Computer system 700 may also include input/output (I/O) devices such as a keyboard 708, a mouse 710, and a display 712.

Computer system 700 may include functionality to execute various components of the present embodiments. In particular, computer system 700 may include an operating system (not shown) that coordinates the use of hardware and software resources on computer system 700, as well as one or more applications that perform specialized tasks for the user. To perform tasks for the user, applications may obtain the use of hardware resources on computer system 700 from the operating system, as well as interact with the user through a hardware and/or software framework provided by the operating system.

In one or more embodiments, computer system 700 provides a system for processing queries of a graph database storing a graph, which includes a set of nodes, a set of edges between pairs of the nodes, and a set of predicates. The system includes a management process that launches a set of child processes for processing the queries. When a query of the graph database is received, the management process transmits the query to one or more of the child processes, receives a result of the query from the one or more child processes, and provides the result in a response to the query.

In addition, one or more components of computer system 700 may be remotely located and connected to the other components over a network. Portions of the present embodiments (e.g., management process, child processes, etc.) may also be located on different nodes of a distributed system that implements the embodiments. For example, the present embodiments may be implemented using a cloud computing system that processes queries of a distributed graph database from a set of remote users.

The foregoing descriptions of various embodiments have presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
launching, by a management process executing on a computer system, a set of child processes for processing queries of a graph database storing a graph, wherein the graph comprises a set of nodes, a set of edges between pairs of nodes in the set of nodes, and a set of predicates;
when a query of the graph database is received, processing the query at the management process by:
transmitting the query to one or more of the child processes;
receiving a result of the query from the one or more child processes; and
providing the result in a response to the query.

2. The method of claim 1, further comprising:
monitoring an execution condition associated with a child process in the set of child processes; and
managing, by the management process, execution of the child process based on the monitored execution condition.

3. The method of claim 2, wherein:
the execution condition comprises an execution error in the child process, and
managing execution of the child process comprises:
restarting the child process when the execution error is recoverable; and
terminating the management process and the set of child processes when the execution error is unrecoverable.

4. The method of claim 2, wherein:
the execution condition comprises a resource usage of the child process, and
managing execution of the child process comprises terminating the child process when the resource usage exceeds a resource usage limit for the child process.

5. The method of claim 4, wherein the resource usage is associated with at least one of:
a processor;
a memory;
a disk input/output (I/O); and
a processing time.

6. The method of claim 1, wherein receiving the result of the query from the one or more child processes comprises:
receiving, from the one or more child processes, an indication that the result is not available from the one or more child processes;
transmitting the query to one or more additional management processes executing on one or more additional computer systems;
receiving one or more subsets of the results from the one or more additional management processes;
providing the one or more subsets of the results to the one or more child processes for aggregating the one or more subsets into the result; and
receiving the aggregated result from the one or more child processes.

7. The method of claim 1, wherein transmitting the query to the one or more child processes comprises:
identifying a size of the query; and
transmitting the query to a child process with a resource usage limit that accommodates the size.

8. The method of claim 1, wherein the set of child processes comprise:
a write process that executes write requests to the graph database; and
one or more read processes that execute read requests to the graph database.

9. The method of claim 1, wherein:
the management process executes in a first runtime environment, and the child processes execute in a second runtime environment that is separate from the first runtime environment.

10. The method of claim 9, wherein the second runtime environment has a higher performance than the first runtime environment.

11. The method of claim 9, wherein the first runtime environment has a higher stability than the second runtime environment.

12. An apparatus, comprising:
one or more processors; and
memory storing instructions that, when executed by the one or more processors, cause the apparatus to:
launch a set of child processes for processing queries of a graph database storing a graph, wherein the graph comprises a set of nodes, a set of edges between pairs of nodes in the set of nodes, and a set of predicates;
when a query of the graph database is received:
transmit the query to one or more of the child processes;
receive a result of the query from the one or more child processes; and
provide the result in a response to the query.

13. The apparatus of claim 12, wherein the memory further stores instructions that, when executed by the one or more processors, cause the apparatus to:
execute, by the one or more child processes, the query against the graph database.

14. The apparatus of claim 12, wherein the memory further stores instructions that, when executed by the one or more processors, cause the apparatus to:
monitor an execution condition associated with a child process in the set of child processes; and
manage execution of the child process based on the monitored execution condition.

15. The apparatus of claim 14, wherein:
the execution condition comprises an execution error in the child process, and
managing execution of the child process comprises:
restarting the child process when the execution error is recoverable; and
terminating the set of child processes when the execution error is unrecoverable

16. The apparatus of claim 14, wherein:
the execution condition comprises a resource usage of the child process, and
managing execution of the child process comprises terminating the child process when the resource usage exceeds a resource usage limit for the child process.

17. The apparatus of claim 12, wherein receiving the result of the query from the one or more child processes comprises:
receiving, from the one or more child processes, an indication that the result is not available from the one or more child processes;
transmitting the query to on one or more computer systems; and
receiving one or more subsets of the results from the one or more computer systems.

18. The apparatus of claim 17, wherein receiving the result of the query from the one or more child processes further comprises:
providing the one or more subsets of the results to the one or more child processes for aggregating the one or more subsets into the result; and
receiving the aggregated result from the one or more child processes.

19. A system, comprising:
a management module comprising a non-transitory computer-readable medium comprising instructions that, when executed by one or more processors, cause the system to:
launch a set of child processes for processing queries of a graph database storing a graph, wherein the graph comprises a set of nodes, a set of edges between pairs of nodes in the set of nodes, and a set of predicates;
when a query of the graph database is received:
transmit the query to one or more of the child processes;
receive a result of the query from the one or more child processes; and
provide the result in a response to the query; and
a processing module comprising a non-transitory computer-readable medium comprising instructions that, when executed by the one or more processors, cause the system to execute, by the one or more child processes, the query against the graph database.

20. The system of claim 19, wherein the non-transitory computer-readable medium of the management module further comprises instructions that, when executed by the one or more processors, cause the system to:
monitor an execution condition associated with a child process in the set of child processes; and
manage execution of the child process based on the monitored execution condition.
